(19) United States
(12) Patent Application Publication
(10) Pub. No.: US 2017/0149914 A1
(43) Pub. Date: May 25, 2017

(54) SCORING DEVICES BASED ON PRIMACY

(71) Applicant: International Business Machines Corporation, Armonk, NY (US)

(72) Inventors: Peter J. Mostachetti, Kingston, NY (US); Christopher D. Wyble, Poughkeepsie, NY (US); Michael J. Young, Poughkeepsie, NY (US)

(21) Appl. No.: 14/950,990

(22) Filed: Nov. 24, 2015

(51) Int. Cl. H04L 29/08; H04L 12/58

(52) U.S. Cl. CPC H04L 67/26; H04L 67/32; H04L 51/36; H04L 51/24

(57) ABSTRACT

A computer program product for managing a user's multiple electronic devices is provided. The computer program product includes a computer readable storage medium having program instructions embodied therewith. The program instructions are readable and executable by processing circuits of at least the multiple electronic devices to cause the processing circuits to calculate primacy scores of each of the multiple electronic devices, share the calculated primacy scores among the multiple electronic devices, determine which one or more of the multiple electronic devices is a primary device based on the shared primacy scores and a characteristic of a notification upon generation of the notification at any one of the multiple electronic devices or a central computing device and forward the notification from the one of the multiple electronic devices or the central computing device to only the one or more of the multiple electronic devices determined to be a primary device.

### BACKGROUND

The present invention relates to methods of scoring devices based on primacy and, more specifically, to methods of scoring multiple devices used by a user based on primacy relative to the user at any given time and forwarding notifications based on the scoring.

Users with multiple devices often receive multiple notifications on some or all of their electronic devices instead of having those multiple notifications routed to their most “prime” device at any given time. Thus, as we move to an “Internet of Things” world where many electronic devices offer similar functions, a system will be needed to order the primacy of electronic devices for different uses. For example, incoming phone calls or text messages often are sent to every registered electronic device a user owns. This can, in some cases, present an annoyance since the user may have to address each notification separately and can represent a security issue if an unattended device receives a sensitive notification.

Currently, while there are many examples of electronic device systems that manage notifications, none of these systems negotiate a prime device from a plurality of other devices. That is, in some systems, a single device changes its behavior in certain situations based on how the device is interacting with the user or notification options are changed based on a device location or other configurable factors. In other systems, a user may be able to dismiss a notification on one device and have that dismissal made effective on his other devices. In one case, in particular, a method of “forwarding” a notification to a server from a device that is not in active use is provided where the server subsequently forwards that notification to an “active use” device. Here, the non-primary device still receives the notification and the concept of “active use” is based on whether a given device “sees” its user via a camera or “hears” its user via a microphone.

### SUMMARY

According to an embodiment of the present invention, a computer program product for managing a user's multiple electronic devices based on primacy scores is provided. The computer program product includes a computer readable storage medium having program instructions embodied therewith. The program instructions are readable and executable by processing circuits of at least the multiple electronic devices to cause the processing circuits to calculate primacy scores of each of the multiple electronic devices, share the calculated primacy scores among the multiple electronic devices, determine which one or more of the multiple electronic devices is a primary device based on the shared primacy scores and a characteristic of a notification upon generation of the notification at any one of the multiple electronic devices or a central computing device and forward the notification from the one of the multiple electronic devices or the central computing device to only the one or more of the multiple electronic devices determined to be a primary device.

According to another embodiment of the present invention, a computing system for managing a user's multiple electronic devices based on primacy scores is provided. The computing system includes a computer readable storage medium having instructions stored thereon that are executable by processing circuits of at least the multiple electronic devices to cause the processing circuits to calculate primacy scores of each of the multiple electronic devices, share the calculated primacy scores among the multiple electronic devices, determine which one or more of the multiple electronic devices is a primary device based on the shared primacy scores and a characteristic of a notification upon generation of the notification at any one of the multiple electronic devices or a central computing device and forward the notification from the one of the multiple electronic devices or the central computing device to only the one or more of the multiple electronic devices determined to be a primary device.

According to yet another embodiment of the present invention, a computer-implemented method for managing a user's multiple electronic devices based on primacy scores. The method includes calculating primacy scores of each of the multiple electronic devices, sharing the calculated primacy scores among the multiple electronic devices, determining which one or more of the multiple electronic devices is a primary device based on the shared primacy scores and a characteristic of a notification upon generation of the notification at any one of the multiple electronic devices or a central computing device and forwarding the notification from the one of the multiple electronic devices or the central computing device to only the one or more of the multiple electronic devices determined to be a primary device.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic illustration of a computing system;

FIG. 2 is a schematic drawing of a computer program product;

FIG. 3 is a schematic diagram of a web-like arrangement of multiple computing devices;

FIG. 4 is a schematic diagram of a spoked wheel arrangement of multiple computing devices;

FIG. 5 is an illustration of a data structure including device identification and score information;

FIG. 6 is a flow diagram illustrating a deployment process of the computer program product of FIG. 2; and

FIG. 7 is a flow diagram illustrating a computer-implemented method for managing a user's multiple electronic devices based on primacy scores.

### DETAILED DESCRIPTION

As will be described below, a computer program product, a computing system and a computer-implemented method are provided for managing a user's multiple electronic devices. The multiple electronic devices calculate a “primacy score” based at least on heuristics, that score is shared with a server or with other known ones of the multiple electronic devices and the multiple electronic devices and the server use the scores to decide which device is the “primary device” at a moment at which a notification, such as a text message or a phone call or a calendar/timer/temperature/health reminder, is generated for any given purpose (e.g., the “primary device” may be different for whether the action is a phone call versus a text message). The notification is then sent to the primary device instead of to all of the user's multiple electronic devices.

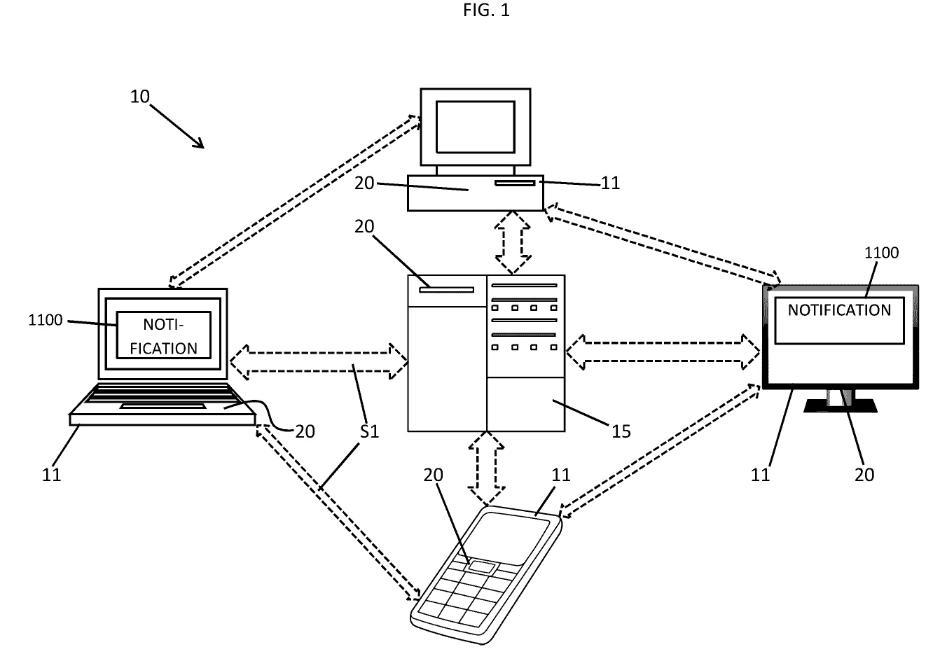

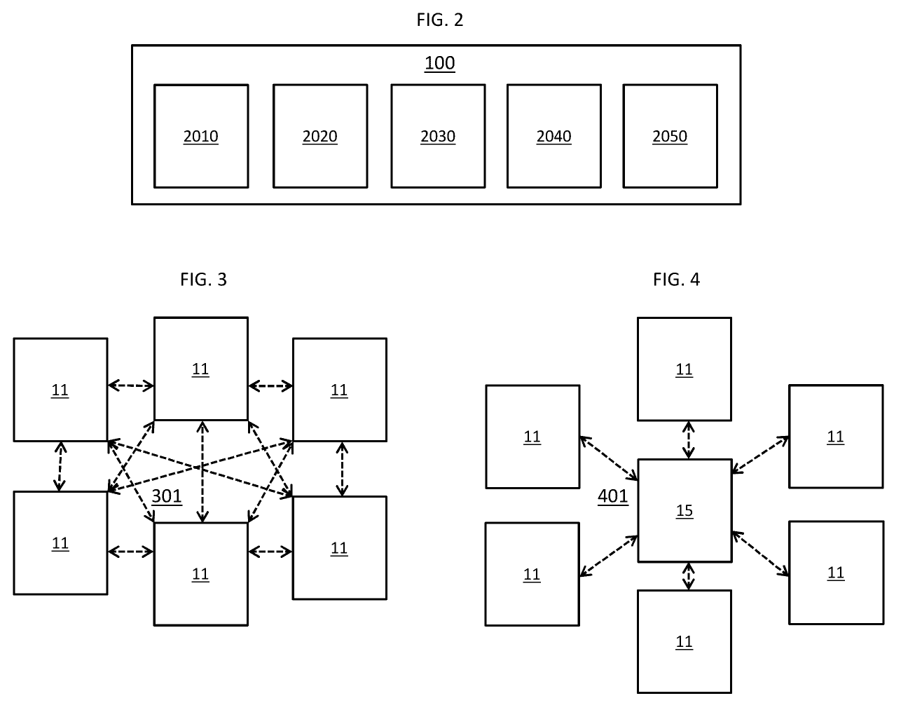

With reference to FIG. 1, a computing system 10 is provided and may be configured for example as an enterprise computing system or as a personal computing system. In either case, the computing system 10 includes multiple electronic devices 11 and, in some cases, at least one server 15. The multiple electronic devices 11 may include, but are not limited to, electronic devices of varying functionalities and size such as phones, tablets, watches, smart clothing, refrigerators, televisions, personal computers and appliances. In any case, the multiple electronic devices 11 and the server 15 are configured to be networked together for communication purposes. In accordance with embodiments, each of the multiple electronic devices 11 and the server 15 may include among other features a processing circuit 20 and a computer program product 100 (see FIG. 2) for managing a user's multiple electronic devices. They may also include a display, user input devices, a memory unit and a networking unit.

For each of the multiple electronic devices 11 and the server 15, the processing circuit 20 may be provided as a micro-processor, a central processing unit (CPU) or any other suitable processing device. The display may be provided as a monitor and is configured to display data and information as well as a graphical user interface to an administrator or user. The user input devices may be provided as a mouse and a keyboard combination and are configured to allow the administrator or user to input commands to the processing circuit 20. The networking unit may be provided as an Ethernet or other suitable networking device by which the multiple electronic devices 11 and the server 15 are communicative.

Several or all of the multiple electronic devices 11 and the server 15 may be configured to generate a notification 1100 to be delivered to the user. The notification 1100 serves to alert the user of an event that may be internal or external with respect to the computing system 10. A type of the notification 1100 varies by electronic device type. For example, the notification 1100 may take the form of a text messaged, emailed or telephoned notification of an incoming text message or email in the case of one or more of the multiple electronic devices 11 being a phone or a tablet. Alternatively, the notification 1100 may take the form of an alert generated by a refrigerator or appliance that is issued to the user as a read-out on a display of the refrigerator or the appliance or as a text messaged, emailed or telephoned alert.

In any case, the notification 1100 would be normally issued to the user by the multiple electronic devices 11. In accordance with the present invention, however, the notification 1100 is only issued to the user by the one of the multiple electronic devices 11 deemed to be the user's primary device as will be described below.

With reference to FIG. 2, the computer program product 100 includes a computer readable storage medium and may be installed in a memory unit of each of the multiple electronic devices 11 and the server 15 as firmware or as lower level executable program instructions. In accordance with embodiments, the computer program product 100 may include first-fifth sequences of program instructions 2010-2050. When executed, the first and second sequences of program instructions 2010 and 2020 respectively cause the processing circuit 20 of each of the multiple electronic devices 11 to calculate the primacy score of the corresponding one of the multiple electronic devices 11 using heuristic weights assigned to a set of input values and user inputted commands and to directly or indirectly share the calculated primacy scores among the multiple electronic devices 11 and, where applicable, a central computing device (hereinafter referred to as the server 15).

In accordance with embodiments, the calculation of the primacy scores by each of the multiple electronic devices 11 may be conducted using available functionalities and sensors to determine the likelihood that the corresponding one of the multiple electronic devices 11 is the user's “primary device” at any given moment and for a configured set of types of the notification 1100. In accordance with embodiments, the “primacy score” is calculated using heuristic weights assigned to a set of input values. The value assigned heuristic weights may be reflective of a type of device (i.e., a smart thermostat might never be the primary device for a phone call or a notification of a phone call), results from sensor readings available to the device, a determination of whether the device is turned on, in use, receiving input and/or displaying output (i.e., an outputting television might be very highly weighted as being “primary” since there is an implication that the user is actively viewing the television). The value assigned heuristic weights may also be reflective of prior feedback and/or configuration inputs provided by the user to be indicative of a desire to regard a given device as the primary device for a given notification (i.e., is the device a “secure” device or has the user stated expressly that no notifications should occur on this device between certain hours).

When executed, the third sequence of program instructions 2030 cause the processing circuits 20 to determine which one or more of the multiple electronic devices 11 is a primary device based on the shared primacy scores and a characteristic of the notification 1100 (see FIG. 1) upon the moment at which the generation of the notification 1100 occurs at any one of the multiple electronic devices 11 or the server 15. Finally, when executed, the fourth and fifth sequences of program instructions 2040 and 2050 respectively forward the notification 1100 from the one of the multiple electronic devices 11 or the server 15 to only the one or more of the multiple electronic devices 11 determined to be primary devices and to cooperatively generate a table of primacy scores for reference by the multiple electronic devices 11 and the server 15.

In accordance with alternative embodiments and, with reference to FIGS. 3 and 4, the multiple electronic devices 11 may communicate with one another directly (see FIG. 3) and/or indirectly (see FIG. 4). In the case of direct electronic device communication, the multiple electronic devices 11 may be disposed in signal communication with one another to define a web-like network 301 as shown in FIG. 3. On the other hand, in the case of indirect electronic device communication, the multiple electronic devices 11 may be disposed in signal communication with each other through a centralized communication hub at the server 15 to thus define a spoked wheel network 401 as shown in FIG. 4. Of course, it is to be understood that the embodiments of FIGS. 3 and 4 can be interchanged and used together. For example, a smart door lock might not communicate with server 15 but might instead communicate with a security device that does communicate with the server 15. In any case, the second sequence of program instructions 2020 cause the processing circuits 20 to share the calculated primacy scores among the multiple electronic devices 11 directly or indirectly via the server 15.

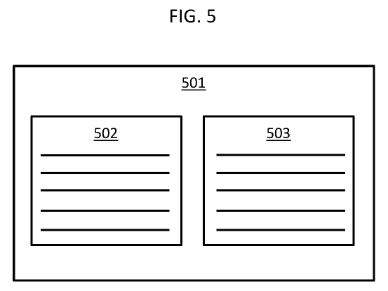

In accordance with embodiments, when executed, the third sequence of program instructions 2030 cause the processing circuits 20 to determine that the one of the multiple electronic devices having a highest primacy score is the primary device at the moment of the generation of the notification. With reference back to FIG. 1 and with additional reference to FIG. 5, this determination may be achieved by the multiple electronic devices 11 and the server 15 cooperatively generating a data structure 501 of primacy scores for reference by each of the multiple electronic devices 11 and the server 15 in accordance with the fifth sequence of program instructions 2050 being executed. That is, as shown in FIG. 1, upon execution of the fifth sequence of program instructions 2050, each of the multiple electronic devices 11 may issue a signal S1 to the other multiple electronic devices 11 and the server 15 (either directly or indirectly). This signal S1 may include identification information for the originating one of the multiple electronic devices 11 and the corresponding primacy score. Subsequently, as shown in FIG. 5, each of the multiple electronic devices 11 and the server 15 generates a localized or distributed data structure 501 that includes device identification fields 502 and corresponding primacy score fields 503. From this data structure, each one of the multiple electronic devices 11 and the server 15 may be configured and disposed to determine a same primary device so that the notification can be forwarded thereto.

In an exemplary case, in an execution of the first-fifth sequences of program instructions 2010-2050 within the computing system 10, the server 15 may not ring all of the user's multiple electronic devices 11 when there is an incoming phone call. Instead, the server 15 may route the ringing and the call directly to the one of the multiple electronic devices 11 that has the highest primacy score for receiving phone calls to the user (e.g., the user's cell phone if it is on and carried by the user or the user's tablet if the cell phone is off). Similarly, the user's personal calendar assistant application would display a reminder notification “Harry's Secret Surprise Birthday Party Tomorrow!” only to the user and not to an unattended device near Harry.

In accordance with further embodiments, a primary device could automatically be unlocked based on its primacy score, actions could be taken based on a device's primacy score and/or the primacy scores of other devices, more than one device could be considered primary at a same time if their scores were sufficiently similar or within a predetermined range of one another (e.g., a stove timer might beep on the stove as well as forwarding that beep onto other devices) and the weights for given input values can be adjusted via feedback from the user in several ways. For example, the device the user eventually responds to the notification with could apply weight more heavily to that device's sensor readings or the user could be given an option to suggest a better device for a particular notification and that input would affect the weights for the devices in question in the future.

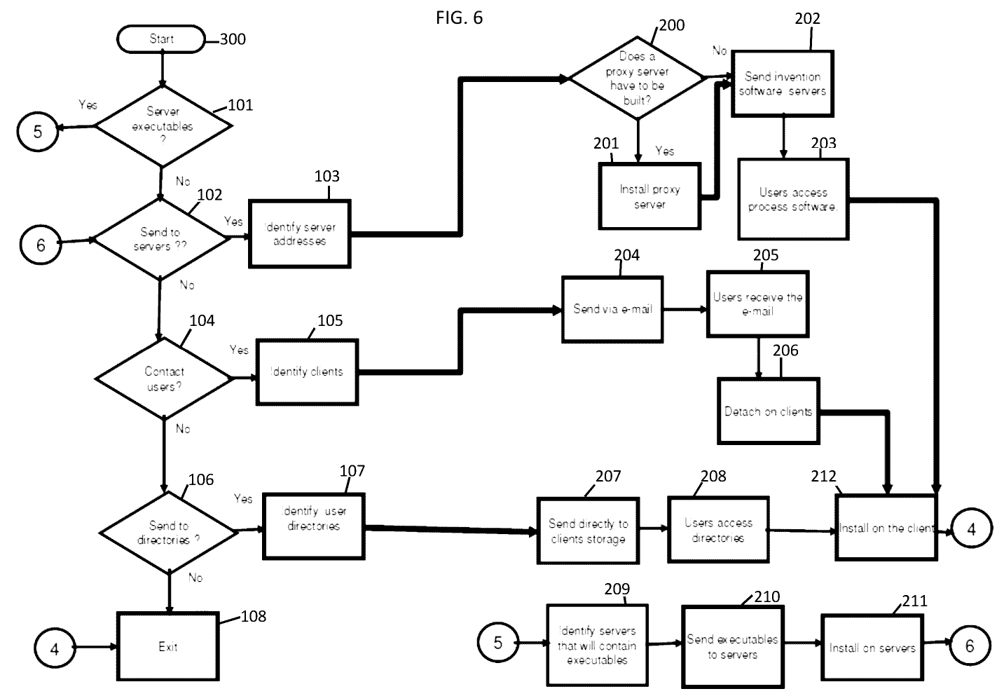

In accordance with embodiments and, with reference to FIG. 6, a deployment process of the computer program product described above is provided. The process begins at block 300 and at block 101 with a determination of whether the first-fifth sequences of program instructions 2010-2050 will reside on server 15 when executed. If so, then the server 15 is identified at block 209. The first-fifth sequences of program instructions 2010-2050 are then transferred directly to the server 15 storage via FTP or some other protocol or by copying though the use of a shared file system at block 210 such that the first-fifth sequences of program instructions 2010-2050 are installed on the servers at block 211.

Next, a determination is made on whether the first-fifth sequences of program instructions 2010-2050 are to be deployed by having users access to the first-fifth sequences of program instructions 2010-2050 on server 15 at block 102. If so, the server 15 addresses that will store the first-fifth sequences of program instructions 2010-2050 are identified at block 103 and a determination is made if a proxy server is to be built at block 200 for storage. A proxy server is a server that sits between a client application, such as a Web browser, of first computing device 11 and server 15 and operates by intercepting all requests to the server 15 to see if it can fulfill the requests itself. If not, the proxy server forwards the request to server 15. The two primary benefits of a proxy server are to improve performance and to filter requests.

If a proxy server is required, then the proxy server is installed at block 201 and the first-fifth sequences of program instructions 2010-2050 are sent via a protocol, such as FTP, or by being copied directly from the source files to the server 15 files via file sharing at block 202. Another embodiment involves sending a transaction to the (one or more) server 15 that contained the process software, and have the server 15 process the transaction and then receive and copy the process software to the server 15 file system. Once the process software is stored, the users may then access the first-fifth sequences of program instructions 2010-2050 and copy to the same to their respective client computer file systems at block 203. Alternatively, the server 15 may automatically copy the first-fifth sequences of program instructions 2010-2050 to each client and then run an installation program for the first-fifth sequences of program instructions 2010-2050 on each client computer whereby the user executes the program that installs the first-fifth sequences of program instructions 2010-2050 on his client computer at block 212 and then exits the process at block 108.

At block 104, a determination is made as to whether the first-fifth sequences of program instructions 2010-2050 are to be deployed by being sent to users via e-mail. If a result of the determination is affirmative, the set of users are identified together with the addresses of the user client computers at block 105 and the first-fifth sequences of program instructions 2010-2050 are sent via e-mail to each of the users' client computers. The users then receive the e-mail at block 205 and detach the first-fifth sequences of program instructions 2010-2050 from the e-mail to a directory on their client computers at block 206. The user executes the program that installs the first-fifth sequences of program instructions 2010-2050 on his client computer at block 212 and then exits the process at block 108.

Lastly, a determination is made on whether the first-fifth sequences of program instructions 2010-2050 will be sent directly to user directories on their client computers at block 106. If so, the user directories are identified at block 107 and the process software is transferred directly to the user's client computer directories at block 207. This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the first-fifth sequences of program instructions 2010-2050 at block 208, execute the program that installs the first-fifth sequences of program instructions 2010-2050 at block 212 and then exit the process at block 108.

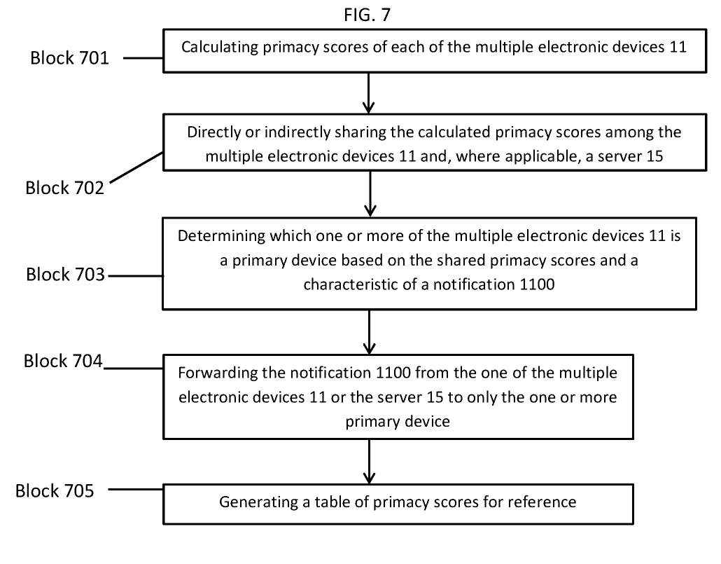

With reference to FIG. 7, a computer-implemented method for managing a user's multiple electronic devices 11 based on primacy scores is provided. The Computer-implemented method includes calculating primacy scores of each of the multiple electronic devices 11 at block 701, directly or indirectly sharing the calculated primacy scores among the multiple electronic devices 11 at block 702, determining which one or more of the multiple electronic devices 11 is a primary device based on the shared primacy scores and a characteristic of a notification 1100 at block 703 upon generation of the notification 1100 at any one of the multiple electronic devices 11 or server 15 and forwarding the notification 1100 from the one of the multiple electronic devices 11 or the server 15 to only the one or more primary device at block 704. The computer-implemented method further includes generating a table of primacy scores for reference at block 705.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is understood in advance that although this disclosure includes a detailed description of implementations of the teachings recited herein in conjunction with a computing environment, other implementations are possible. These include, but are not limited to, implementations based on cloud computing environments.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

The characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer program product for managing a user's multiple electronic devices based on primacy scores, the computer program product comprising a computer readable storage medium having program instructions embodied therewith, the program instructions being readable and executable by processing circuits of at least the multiple electronic devices to cause the processing circuits to:
calculate primacy scores of each of the multiple electronic devices;
share the calculated primacy scores among the multiple electronic devices;
upon generation of a notification at any one of the multiple electronic devices or a central computing device, determine which one or more of the multiple electronic devices is a primary device based on the shared primacy scores and a characteristic of the notification; and
forward the notification from the one of the multiple electronic devices or the central computing device to only the one or more of the multiple electronic devices determined to be a primary device.

2. The computer program product according to claim 1, wherein the program instructions further cause the processing circuit of each of the multiple electronic devices to calculate the primacy score of the corresponding electronic device.

3. The computer program product according to claim 1, wherein the program instructions further cause the processing circuits to calculate the primacy scores using heuristic weights assigned to a set of input values and user inputted commands.

4. The computer program product according to claim 1, wherein the program instructions further cause the processing circuits to share the calculated primacy scores among the multiple electronic devices directly.

5. The computer program product according to claim 1, wherein the program instructions further cause the processing circuits to share the calculated primacy scores among the multiple electronic devices via the central computing device.

6. The computer program product according to claim 1, wherein the one or more of the multiple electronic devices having highest primacy scores is determined to be a primary device.

7. The computer program product according to claim 1, where the program instructions further cause the processing circuits to cooperatively generate a table of primacy scores for reference.

8. A computing system for managing a user's multiple electronic devices based on primacy scores, the computing system comprising a computer readable storage medium having instructions stored thereon that are executable by processing circuits of at least the multiple electronic devices to cause the processing circuits to:
calculate primacy scores of each of the multiple electronic devices;
share the calculated primacy scores among the multiple electronic devices;
upon generation of a notification at any one of the multiple electronic devices or a central computing device, determine which one or more of the multiple electronic devices is a primary device based on the shared primacy scores and a characteristic of the notification; and
forward the notification from the one of the multiple electronic devices or the central computing device to only the one or more of the multiple electronic devices determined to be a primary device.

9. The computing system according to claim 8, wherein the instructions further cause the processing circuit of each of the multiple electronic devices to calculate the primacy score of the corresponding electronic device.

10. The computing system according to claim 8, wherein the instructions further cause the processing circuits to calculate the primacy scores using heuristic weights assigned to a set of input values and user inputted commands.

11. The computing system according to claim 8, wherein the instructions further cause the processing circuits to share the calculated primacy scores among the multiple electronic devices directly.

12. The computing system according to claim 8, wherein the instructions further cause the processing circuits to share the calculated primacy scores among the multiple electronic devices via the central computing device.

13. The computing system according to claim 8, wherein the one or more of the multiple electronic devices having highest primacy scores is determined to be a primary device.

14. The computing system according to claim 8, where the instructions further cause the processing circuits to cooperatively generate a table of primacy scores for reference.

15. A computer-implemented method for managing a user's multiple electronic devices based on primacy scores, comprising:
calculating primacy scores of each of the multiple electronic devices;
sharing the calculated primacy scores among the multiple electronic devices;
upon generation of a notification at any one of the multiple electronic devices or a central computing device, determining which one or more of the multiple electronic devices is a primary device based on the shared primacy scores and a characteristic of the notification; and
forwarding the notification from the one of the multiple electronic devices or the central computing device to only the one or more of the multiple electronic devices determined to be a primary device.

16. The computer-implemented method according to claim 15, wherein the calculating comprises calculating the primacy scores using heuristic weights assigned to a set of input values and user inputted commands.

17. The computer-implemented method according to claim 15, wherein the sharing comprises sharing the calculated primacy scores among the multiple electronic devices directly.

18. The computer-implemented method according to claim 15, wherein the sharing comprises sharing the calculated primacy scores among the multiple electronic devices via the central computing device.

19. The computer-implemented method according to claim 15, wherein the determining comprises determining that the one or more of the multiple electronic devices having highest primacy scores is a primary device.

20. The computer-implemented method according to claim 15, further comprising generating a table of primacy scores for reference.
